(19) United States
(12) Patent Application Publication
(10) Pub. No.: US 2013/0041790 A1
(43) Pub. Date: Feb. 14, 2013

(54) METHOD AND SYSTEM FOR TRANSFERRING AN APPLICATION STATE

(71) Applicants: Sivakumar Murugesan, San Diego, CA (US); Sathyabama Singaravelu, San Diego, CA (US)

(72) Inventors: Sivakumar Murugesan, San Diego, CA (US); Sathyabama Singaravelu, San Diego, CA (US)

(21) Appl. No.: 13/208,747

(22) Filed: Aug. 12, 2011

(51) Int. Cl. G06Q 30/00; G06F 15/16

(52) U.S. Cl. 705/30; 709/217

(57) ABSTRACT

Systems and methods are for using a computer-based application session on one device and continuing the same session on one or more other devices without interruption of the session, according to certain embodiments of the invention. This occurs by a transferring or cloning of the application along with its state from one device to one or more others using a wired or wireless communication link or network. Embodiments further include the transfer of an application state to one or more other users by a transfer to their devices while continuing with the first user's session on his/her device.

### 1. FIELD OF INVENTION

Embodiments of the invention relate methods and systems for reconstructing or resuming one or more application sessions on one or more other electronic devices based upon one or more sessions that had originated on a first electronic device.

### 2. BACKGROUND

When a user is in the middle of some computer-based session or operation using an application (e.g., a spread sheet, a word processor, a game or a web browser) on a device (e.g., a desktop computer) and the user wants to move from his/her current location for some reason, the user often has to stop or pause the application session. The user must return to the original location at a later point in time to continue the session. This frequently causes an interruption in the operation.

Some solutions permit running the same application on a different platform of the same type (e.g., Android or Apple platforms), but they often do so without continuity of the application session. Software development kits (SDKs) generally do not have the ability to continue the same session on another platform. Thus when using another platform the application must start a new session at the beginning. For example if the user was playing an electronic chess game on a desktop computer, and the user wanted to change his location, it often would be necessary to pause or stop the game. If the user later wanted to play the chess game on another device, such as for example on a smart phone, then the game would have to be started all over again and played from the beginning.

### SUMMARY OF CERTAIN EMBODIMENTS

Broadly speaking, embodiments of the invention relate to systems and methods for using a computer-based application on one device and continuing the same session or operation on another device of the user's choice without interruption of the session. Examples include the playing of a game, the rendering of audio/visual content, the executing of office productivity software, the using of a web browser and any other application on a device. This is achieved by a seamless transferring or cloning of the application state or instance from one device at particular point in time to one or more other devices at another time using a wired or wireless network. Embodiments further include the cloning or transfer of a current state of an operation of an application to one or more other users by a transfer to their devices while continuing with the first user's session on his/her device.

In one embodiment, a server receives an application state of a first application executing on a first device. The server further receives a request from a second device for the application state. In response to this request, the server transmits a second application to the second device and further transmits the application state of the first application to the second device. The second application is configured to execute on the second device so that the second application begins in a state approximately equivalent to the application state of the first device.

In another aspect, the server determines whether the second application already resides on the second device. If it does, then no application is transmitted. However if it is determined that the second application does not reside on the second device, the server then determines an identity of an operating system or a hardware configuration of the second device. Then the server transmits to the second device the second application which is configured to operate on the second device's operating system and hardware configuration.

In an alternative embodiment, a server receives an application first state, an application second state and an application third state, each of which is of a first application executing on a first device. The server stores the application first state, the application second state and the application third state. The server further receives a request from a second device for the application first state, wherein the second device is configured to provide an option for requesting any one of the application first state, the application second state and the application third state. In response to this request, the server transmits a second application to the second device and further transmits the application first state to the second device. The second application is configured to execute on the second device so that the second application begins in a state approximately equivalent to the application first state of the first device.

In yet further alternative embodiments, the above-described communications and transmissions involving the first and second devices can occur directly between them without the use of the server.

In an alternative embodiment, a first application session of a first user is identified, wherein the first application session comprises an application server and a first device. First device-side session information and server-side session information is stored. A communication connection is established between a second device and the application server. Also a communication connection is established between a third device and the application server. The first device-side session information is conveyed to the second device and to the third device. A second application session of a second user is conducted, wherein the second application session comprises the second device and the application server, and begins in a state approximately equivalent to a state in which the first application session had been saved. A third application session of a third user is conducted, wherein the third application session comprises the third device and the application server, and begins in a state approximately equivalent to a state in which the first application session had been saved.

In yet another embodiment, an application first session, an application second session and an application third session are identified, each of which comprises an application server and a first device, and each of which is based upon executing a primary application by the application server. Then there are stored: (a) first device-side first session information and server-side first session information corresponding to the application first session, (b) first device-side second session information and server-side second session information corresponding to the application second session, and (c) first device-side third session information and server-side third session information corresponding to the application third session. A request from a second device is received which is for a state at which the application first session, the application second session, or the application third session had been saved. The second device is configured to provide an option for selecting any of the states at which the application first session, the application second session, and the application third session had been saved. The state requested by the second device is conveyed to it. An application fourth session is conducted that comprises the second device and the application server, that begins in a state approximately equivalent to the requested state, and that is based upon executing the primary application by the application server.

There are additional aspects to the present inventions. It should therefore be understood that the preceding is merely a brief summary of some embodiments and aspects of the present inventions. Additional embodiments and aspects are referenced below. It should further be understood that numerous changes to the disclosed embodiments can be made without departing from the spirit or scope of the inventions. The preceding summary therefore is not meant to limit the scope of the inventions. Rather, the scope of the inventions is to be determined by appended claims and their equivalents.

### BRIEF DESCRIPTION OF THE DRAWINGS

These and/or other aspects and advantages of the present invention will become apparent and more readily appreciated from the following description of certain embodiments, taken in conjunction with the accompanying drawings of which:

FIG. 1 is a simplified block diagram of a hardware environment in which embodiments of the present invention may be applied;

FIG. 2 is a simplified process flow diagram of a method for transfer by one user of a state of an application to a plurality of other users;

FIG. 3 is a simplified process flow diagram of a method for transfer of a plurality of states of an application according to an alternative embodiment of the invention;

FIG. 4 is a simplified process flow diagram of a method of transferring an application state of an application executing on a server according to an alternative embodiment of the invention; and

FIG. 5 is a simplified process flow diagram of a method wherein a plurality of application states is saved during use of an application that is executing on a server according to an alternative embodiment of the invention.

### DETAILED DESCRIPTION

The following description is of the best mode presently contemplated for carrying out the invention. Reference will be made in detail to embodiments of the present invention, examples of which are illustrated in the accompanying drawings, wherein like reference numerals refer to like elements throughout. It is understood that other embodiments may be used and structural and operational changes may be made without departing from the scope of the present invention.

Embodiments of the invention include systems and methods for using a computer-based application on one device and continuing the same session or operation in another user device without interruption. Examples include the playing of a game, the rendering of audio/visual content, the executing of office productivity software, the using of a web browser or any other application on a device. This is achieved by a transferring or cloning of the application state or instance from one device to one or more other devices using a wired or wireless communication link or network. Embodiments further include the cloning or transfer of a current state of an operation of an application to one or more other users by a transfer to their devices while continuing with the first user's operation in his/her device.

In one example a first user can be playing a chess game on a desktop computer. If during the middle of this session, the first user wants to change his/her location, he/she can transfer the current state of the chess game session to his/her mobile phone and continue using the chess game application that is either already installed on the mobile phone or is downloaded from a server, such as for example an application store-based server. The first user can continue playing the chess game from the point in the initial game session where he/she had stopped while using the desktop computer.

As another example, the first user can bring the chess game to some state during the middle of the session and challenge one or a plurality of other users to continue the game starting at that point in the play by transferring the current state of game to one or a plurality of other devices. Moreover this first user, after completing his/her portion of the game session, can clone the state and send it to another user's queue in another device or the same device so that the other user can complete this portion of the application session and then return a second state back to the first user or give it to other users for further completion. In yet another example, the first user can store different states of the same game and later continue from each state by taking a different route or branch in the game. In general, by transferring an application state a user's operation or session can continue without interruption at any time in one or more devices located anywhere. Thus embodiments of the invention treat all devices as computing platforms, and a session of any operation, game or application can move from one platform to one or more other platforms and continue from the state where they had stopped in the session on the initial platform.

In order for a user to store a current state whenever desired and to allow him/her to start from this stored state, embodiments of the invention use software development kits (SDKs). The SDKs implement a way to store the current state and to start from the stored state so that developers of applications do not need to worry about how to store and start from any given, stored state.

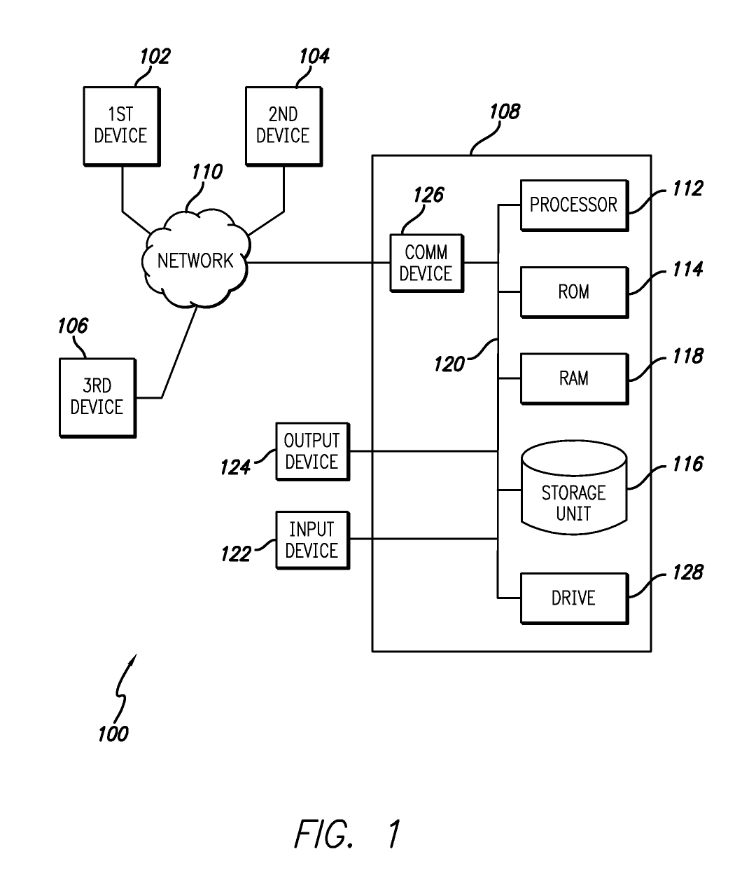

Referring to FIG. 1, there is shown an exemplary configuration of a hardware environment in which embodiments of the present invention may be applied. A communication system 100, which is configured to send, receive, store, organize and generate applications and their states, is comprised of a first client or device 102, a second device 104, a third device 106 and a server 108. The server 108 and the first, second and third clients 102, 104, 106 are each connected or coupled to each other via a network 110 which can be the Internet for example. The connections can be wireless or via one or more cables or via any combination thereof. In the illustrated example, only three clients or devices and one server are shown, but those skilled in the art will appreciate that any number of devices and servers may be connected to the network 110. The server 108 provides functions for transferring applications, application states, electronic messages and other data from one device to another or to the server 108, sometimes via other message servers.

The server 108 includes a processor 112 configured to execute a variety of processing operations as directed by programs and applications stored in a read-only memory (ROM) 114 or loaded from a storage unit 116 into a random access memory (RAM) 118. (While FIG. 1 shows one processor, alternative embodiments include a plurality of processors.) The processor 112, the ROM 114, the RAM 118 and the storage unit 116 are coupled or interconnected via a bus 120. The storage unit 116 includes a non-transitory, computer-readable storage medium and is for storing relatively large quantities of data, applications, etc. The storage unit 116 can be one or more hard disk drives, flash memory devices, optical drives, etc. The RAM 118 also stores data and so on necessary for the processor 112 to execute a variety of applications and processing operations as required. The ROM 114, the RAM 118 and/or the storage unit 116 stores operating software and applications that are used along with the processor 112 to enable the operation of the server 108.

The system 100 further includes at least one input device 122, such as for example, a keyboard and a mouse, a microphone for receiving voice or other sound input, a sensor for detecting motion, a pointing device, a touch screen display, or a remote-controlled wireless input unit, such as for example a television remote control-type unit. Alternative embodiments can include any combination of the foregoing types of input devices, as well as other input devices. Thus the system 100 permits user input via a user action that includes clicking a mouse button when a cursor is positioned over a pre-defined area of an output device 124, such as for example a display unit based upon a LCD. (The output device 124 can further include a speaker for providing voice prompts and spoken words, music and system tones.) Other user actions for input can include a generation by the user of a sound or movement, a selection using the television-type remote control unit, a depressing of a key on the keyboard, a movement of the pointing device or a touching on the touch screen display with the pointing device or with the user's finger, or a selection of a displayed indication.

The bus 120 further couples or connects the input device 122, the output device 124, the storage unit 116, and a communication device 126. The communication device 126 can be a modem, a network interface card (NIC), a wireless access card or adapter, or other terminal adapter, for example. The communication device 126 executes communication processing via the network 110, sends data supplied from the processor 112, and outputs data received from the network 110 to the processor 112, the RAM 118, and the storage unit 116. The communication device 126 also communicates analog signals or digital signals with other clients.

The bus 120 is also connected or coupled to a drive 128 as required on which a non-transitory, computer-readable storage medium, such as a magnetic disk, an optical disk, a magneto-optical disk, or a semiconductor memory for example, is loaded with computer applications containing instructions or with other data read from any of these storage media. These instructions and data, when executed by the processor 112, cause it to perform a plurality of methods or functions.

Although not shown in detail, the first, second and third clients or devices 102, 104, 106 are also each configured as a computer that has a generally similar configuration as that of the server 108. While FIG. 1 shows one configuration of the server 108 and devices, alternative embodiments include a set top box, a personal computer, a cellular phone, a so-called “smart” phone, a portable digital assistant, a tablet computer and any other type of a computer or processor-driven device. Moreover, alternative embodiments need not incorporate a server, but rather may include a communication among the first, second and third clients directly with each other as opposed to communication via the server.

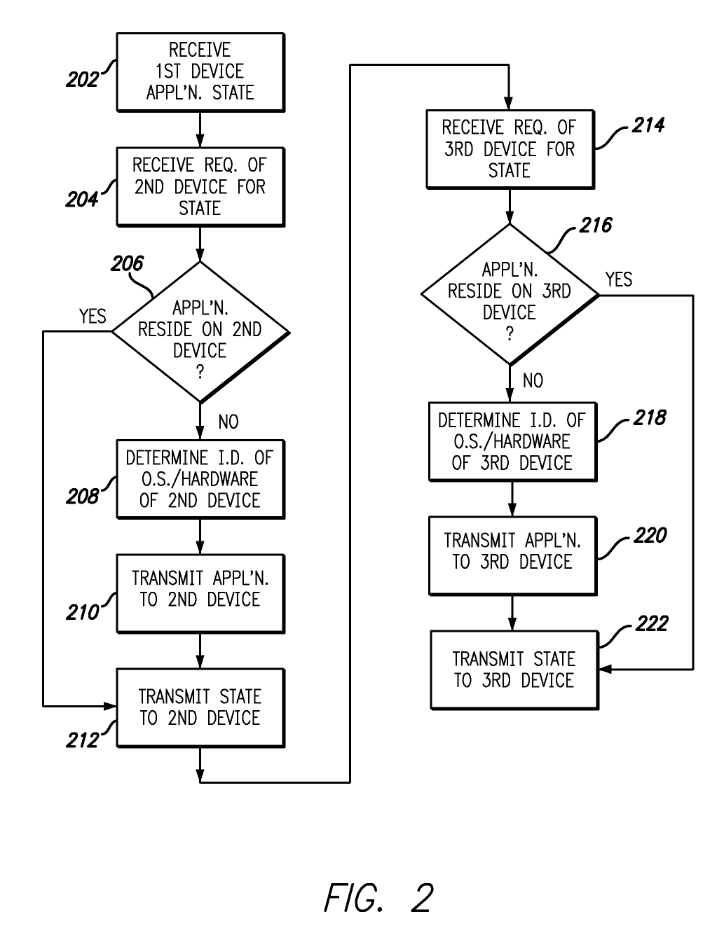

As previously mentioned, embodiments of the invention provide for the transfer by one user of a state of an application on one device to a plurality of other users who are using other devices. FIG. 2 illustrates a simplified process flow of one such embodiment. The process starts with the receipt by a server or other device of an application state of a first application executing on a first device that is being used by a first user. (Step 202) As noted, one example of such an application is a chess game where the application state represents an intermediate stage in a chess game session prior to its completion. Next in response to a request being initiated by a second user of a second device, the server receives this request for the application state of the first application. (Step 204) The server then determines whether there resides on the second device an application that is capable of executing on the second device so that the application can begin in a state that is approximately equivalent to the application state of the first device. (Step 206) If such an application already resides on the second device, then the server transmits the application state of the first device's application to the second device. (Step 212) On the other hand if the necessary application does not reside on the second device, then the server determines the identity of the operating system of the second device or the hardware configuration of the second device or both. (Step 208) Using this information, the server then selects an appropriate application that can be used by the second device and transmits this application to the second device. (Step 210) The server also transmits the application state of the first application to the second device. (Step 212) As previously mentioned the transferred application is configured to execute on the second device so that this application begins in a state approximately equivalent to the application state of the first device. For example in the case of the above-mentioned chess game, the game would execute on the second device so that the game begins at a point in the middle of the game where the first user had left off and saved the application state.

The process is repeated with respect to a third device and a third user. That is, in response to a request being initiated by the third user, the server receives from the third device a request for the application state of the first application. (Step 214) The server then determines whether there resides on the third device an application that is capable of executing so that it begins in a state that is approximately equivalent to the application state of the first device. (Step 216) If such an application resides on the third device, then the server transmits the application state of the first application to the third device. (Step 222) On the other hand if the necessary application does not reside on the third device, then the server determines the identity of the third device's operating system or hardware configuration or both. (Step 218) Using this information, the server then selects an appropriate application that can be used by the third device and transmits this application to the third device. (Step 220) The server also transmits the application state of the first application to the third device. (Step 222) As previously mentioned the transferred application is configured to execute on the third device so that it begins in a state approximately equivalent to the application state of the first device. While FIG. 2 illustrates a method involving the transfer of an application state to two other users operating two other devices, alternative embodiments include the transfer of an application state to only one other user with one other device, or alternatively the transfer of the application state to three or more other users with three or more other devices.

Alternative embodiments include various digital rights management (DRM) or other content control features. In one embodiment the applications on the second and third devices are disabled after the users have terminated the application sessions that began in the state that is approximately equivalent to the first device application state. In order for those applications to be enabled again, the second and third devices would have to receive a key from the server or other device controlled by a content owner. In other embodiments the applications on the second and third devices are automatically removed or deleted from these devices after the users have terminated these application sessions. In this case the relevant applications would need to be transmitted again from the servers for further use if content control conditions are met.

Yet other embodiments involving DRM features include a determination by a server whether a request for an application state is an authentic request. If it is not authentic, then the server would not transmit the relevant application to the requesting device or not transmit the application state, or not transmit both. This authentication can be determined at a user level where a determination is made whether the relevant application has been purchased or licensed by the user. In this case, for example, the user would enter one or both of a login name and a password. According to another embodiment this authentication can be made on a device level where a determination is made whether the requesting device has been registered with a content owner of the relevant application.

The types of applications and their uses to which embodiments of the invention apply are wide ranging. As previously mentioned one embodiment includes applications that are for playing a game, such as chess. The game has a beginning state, and ending state and a plurality of intermediate states. Thus at some intermediate state or point in the game a first user can send that intermediate state to a plurality of other users who can start their play at that intermediate state. In another embodiment the application is a content player configured to play media content, such as audio, video or audio/video content. The media content has a beginning state, and ending state, and a plurality of intermediate content states. A first user can stop playing the content at some intermediate state or point, and send that state to a plurality of other users who could start playing the same content at the point where the first user had stopped playing it. In yet other embodiments, the application is for office productivity or other business-related uses. The application state includes one or more state attributes comprising usage accounting data. For example this data could include a number of pages or photos printed by the application, a number of words translated by the application, or usage minutes for the amount of time that the application in question is executing.

According to one embodiment the usage minutes for the time an application is executing can be used as a basis for charging a user. For example, if an application has been purchased or licensed for use on a first device, then that application can be “rented” for use on a second device of the same user such that the user's account is charged an amount that is based upon the usage minutes. Thus the second device has a user account associated with the second device. A determination is made whether the first application on the first device has been purchased or licensed. A server receives from the second device an amount of time that the second application executes (e.g., usage minutes). The user account is then charged a monetary amount that corresponds to the amount of time that the second application executes.

According to yet another embodiment, users can be encouraged to purchase or license an application by providing them with monetary awards if they can successfully solve a puzzle or “win” a game or otherwise reach an ending application state or a different application state. For example, a first user or a system server can send an intermediate state of a game application to a second user who is notified that he/she will win a monetary award if he/she can reach an ending game state by “winning” the game or otherwise solving the puzzle. The second user may thus be induced to purchase or license the game application in order to obtain the intermediate game state and to execute the game application starting at the intermediate state in an attempt to “win” the game or reach a different, more advanced intermediate game state or solve the puzzle, etc.

The embodiment described above in connection with FIG. 2 generally relates to the transmitting of a state of an application to a plurality of other devices and users. In an alternative embodiment, a plurality of states are identified and saved during one or more sessions in which one application is executing on one device. These states are made available for use by another device that provides the first user or other users with the ability to select one or more of the plurality of states and commence use of the application on the other device starting at the selected application states.

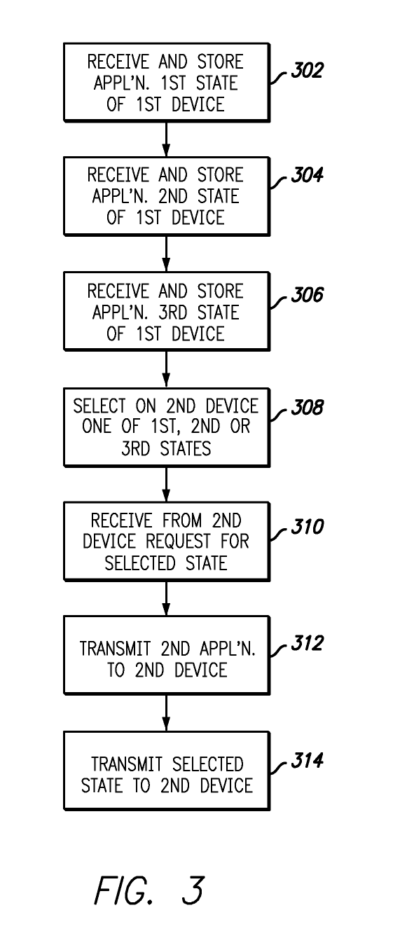

FIG. 3 is a simplified process flow diagram of a machine implemented method of transmitting such a plurality of application states. A server receives and stores an application first state of a first application executing on a first device (step 302), an application second state of the first application executing on the first device (step 304), and an application third state of the first application executing on the first device (step 306). A user of a second device has an option to select any one of the application states and makes a selection on the second device of one of these states. (Step 308) Then the server receives from the second device a request for the selected state. (Step 310). In response to this request, the server determines whether the second device has the necessary application, and if not, the server transmits the required application to the second device. (Step 312) This application is configured to execute on the second device so that the application begins in a state approximately equivalent to the selected application first, second or third state of the first device. The server also transmits the selected first, second or third state to the second device. (Step 314)

In alternative embodiments any number of intermediate application states can be stored on the server or on the second device or both. Any of these states can be retrieved by the second device or by other devices at the same time or at different times. The second device and the other devices can execute the application beginning at the selected state(s) simultaneously or at different times. In yet further embodiments the application states can be “pushed” to the client devices or alternatively the states can be “pulled” by the client devices. As one example a user of a first client device can initiate a query to a server or to a second client device to see if one or more application states are available. If they are available, the user of the first client device is given an option to select and retrieve one or more application states whereupon they are transmitted to the first client device.

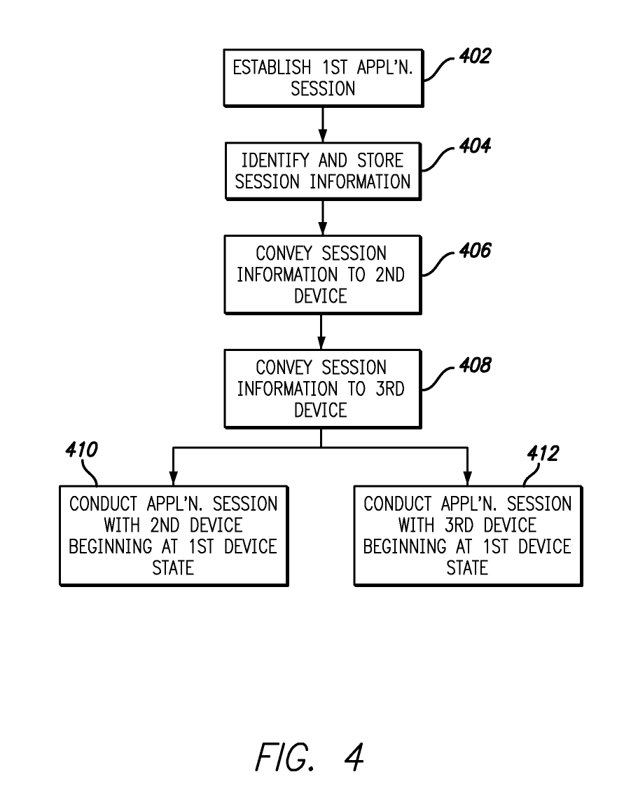

The embodiments of FIGS. 2 and 3 generally relate to applications that are executing on user devices. FIG. 4, on the other hand, illustrates a simplified process flow diagram of a method of transferring an application state of an application that is executing on a server for the benefit or use of a client device. A first user uses a first device to establish a first application session with an application server over a network. (Step 402) The application first session is identified, and at some point in time during the session or at the end of the session, device-side session information and server-side session information is saved and stored. (Step 404) This saving and storing of the session information can be accomplished at the termination of the session or by the entering of a “save” or similar command by the first user who then can continue on with the session. Communications are established between a second device and the server whereupon the device-side session information of the first device is conveyed to the second device. (Step 406) Similarly communications are established between a third device and the server whereupon the device-side session information of the first device is conveyed to the third device. (Step 408) Then an application second session of a second user is conducted, wherein the second session comprises the second device and the server and begins in a state that is approximately equivalent to the state in which the first application session had been saved. (Step 410) Similarly an application third session of a third user is conducted, wherein the third session comprises the third device and the server and begins in a state that is approximately equivalent to the state in which the first application session had been saved. (Step 412)

According to this embodiment, the application sessions of the second and third users using the second and third devices can occur at about the same time during overlapping time periods or can occur at different time periods that do not overlap with one another. Also the sessions of the second and third users can occur while the first user continues on with his/her session. Moreover embodiments of the foregoing invention can include DRM features that are similar to those described above. That is, they include a determination by the server whether the relevant application has been licensed by the second or third user. Also an authentication can be made on a device level where a determination is made as to whether the second or third device has been registered with a content owner of the relevant application.

The embodiment described above in connection with FIG. 4 relates to the transmitting to a plurality of other devices and users of a state of a session executing on a server with a client device. In an alternative embodiment, a plurality of states are identified and saved during one or more sessions in which one application is executing on a server with a client device. These states are made available for use by another device that provides a user with the ability to select one of the plurality of states and commence use of the application starting at the selected application state on the other device with the server.

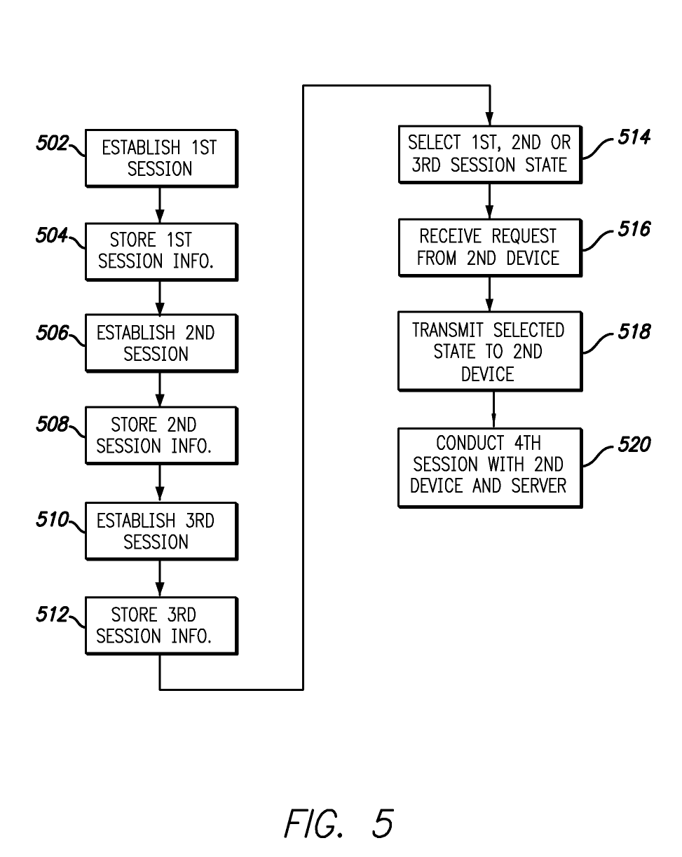

FIG. 5 is a simplified process flow diagram of a machine implemented method of making available such a plurality of application states. A first user uses a first device to establish a first application session with an application server over a network. (Step 502) The application first session is identified, and at some point in time during the first application session or at the termination of this session, device-side first session information and server-side first session information is saved and stored on the server. (Step 504) The first application session is based upon executing a primary application by the application server. This process is then repeated for a plurality of other sessions. That is, an application second session is established by the first user using the first device and is identified. (Step 506) This session comprises the application server and the first device and is based upon executing the primary application by the server. Device-side second session information and server-side second session information is saved and stored on the server. (Step 508) Similarly an application third session is established by the first user using the first device and is identified. (Step 510) As before this third session comprises the application server and the first device and is based upon executing the primary application by the server. Device-side third session information and server-side third session information is saved and stored on the server. (Step 512) This saving and storing of the session information relating to the application first, second and third sessions can be accomplished at the termination of each session or by the entering of a “save” or similar command by the first user at various points in time during a single session so that the user can continue on with the session.

A second user of a second device has an option to select any one of the states at which the first, second or third sessions had been saved. The second user makes a selection on the second device of one of these application states. (Step 514) Then the server receives from the second device a request for the selected state. (Step 516). In response to this request, the server transmits or conveys the selected state to the second device. (Step 518) Finally, the second user conducts a fourth session comprising the second device and the server, wherein the fourth session begins at a state approximately equivalent to the requested state and is based upon the executing of the primary application by the server. (Step 520)

According to one embodiment, the time period during which a session being conducted by the second user can overlap with the time periods of one of the other sessions being conducted by the first user that are not associated with the state that was selected by the second user. Alternatively, the time period during which a session being conducted by the second user is not permitted to overlap with the time periods any of the sessions being conducted by the first user.

Also embodiments of the foregoing invention of FIG. 5 can include DRM features that are similar to those described above in connection with FIG. 2. That is, they include a determination by the server whether the relevant application has been licensed by a user. Alternatively an authentication can be made on a device level where a determination is made as to whether the second device has been registered with a content owner of the relevant application.

In view of the above, it will be appreciated that embodiments of the invention overcome many of the long-standing problems in the art by providing systems and methods for using a computer-based application on one device and continuing the same session or operation seamlessly on another device of the user's choice without interruption. Examples include the using of an Internet browser, the playing of a game, the rendering of audio/visual content, the executing of office productivity software or using any other application on a device. This is achieved by a transferring or cloning of the application state or instance from one device to one or more other devices using a wired or wireless communication link or network. Embodiments further include the cloning or transfer of the current state of the operation of an application to one or more other users by transfer to their devices while continuing with the first user's operation on his/her device.

While the description above refers to particular embodiments of the present invention, it will be understood that many modifications may be made without departing from the spirit thereof. The claims are intended to cover such modifications as would fall within the true scope and spirit of the present invention. The presently disclosed embodiments are therefore to be considered in all respects as illustrative and not restrictive, the scope of the invention being indicated by the claims rather than the foregoing description, and all changes which come within the meaning and range of equivalency of the claims are therefore intended to be embraced therein.

What is claimed is:

1. A machine implemented method comprising:
receiving by a server of an application state of a first application executing on a first device;
receiving by the server of a request from a second device for the application state;
in response to the request from the second device, transmitting by the server a second application to the second device; and
in response to the request from the second device, transmitting by the server the application state of the first application to the second device,
wherein the second application is configured to execute on the second device so that the second application begins in a state approximately equivalent to the application state of the first device.

2. The method of claim 1, further comprising:
determining by the server whether the second application resides on the second device; and
in response to determining that the second application does not reside on the second device, determining by the server of an identity of one of an operating system of the second device and a hardware configuration of the second device,
wherein the transmitting by the server of the second application to the second device, includes transmitting the second application to the second device in response to determining that the second application does not reside on the second device.

3. The method of claim 1 wherein the first and second applications comprise a game having a beginning game state, an ending game state, and a plurality of intermediate game states, and wherein the application state of the first application corresponds to one of the plurality of intermediate game states.

4. The method of claim 3 wherein the receiving by the server of the application state includes receiving the application state of the first application executing on the first device that is being used by a first user,
wherein the request from the second device is initiated by a second user of the second device, wherein the first user is a different individual than the second user,
wherein the ending game state corresponds to one of solving a problem and winning the game, wherein the method further comprises:
receiving a notification that the ending game state was achieved on the second device during a session of the second application that began in a state approximately equivalent to the application state of the first device; and
providing a monetary award to the second user after receiving the notification that the ending game state was achieved on the second device.

5. The method of claim 1 wherein the first and second applications comprise a content player configured to play media content, wherein the media content is one of audio content, video content, and audio/video content,
wherein the media content has a beginning content state, an ending content state, and a plurality of intermediate content states, and
wherein the application state of the first application corresponds to one of the plurality of intermediate content states.

6. The method of claim 1, wherein the receiving by the server of the application state includes receiving the application state of the first application executing on the first device that is being used by a first user, and
wherein the request from the second device is initiated by a second user of the second device, wherein the first user is a different individual than the second user.

7. The method of claim 1, wherein the receiving by the server of the application state includes receiving the application state of the first application executing on the first device that is being used by a first user, the method further comprising:
receiving by the server of a request from a third device for the application state,
wherein the request from the second device is initiated by a second user of the second device, wherein the request from the third device is initiated by a third user of the third device, and wherein the first user, the second user and the third user are different individuals;
in response to the request from the third device, transmitting by the server of a third application to the third device; and
in response to the request from the third device, transmitting by the server the application state of the first application to the third device,
wherein the third application is configured to execute on the third device so that the third application begins in a state approximately equivalent to the application state of the first device.

8. The method of claim 1 wherein the application state is an application first state, the method further comprising:
receiving by the server of an application second state of the first application executing on the first device and an application third state of the first application executing on the first device; and
storing the application first state, the application second state and the application third state,
wherein the second device is configured to provide an option for requesting any one of the application first state, the application second state and the application third state, and
wherein the transmitting of the application first state to the second device includes transmitting the application first state after the storing of the application first state, the application second state and the application third state.

9. The method of claim 1 wherein the second application is further configured to be disabled from further operation on the second device in response to a termination of an application session on the second device, wherein the application session corresponds to the executing of the second application on the second device beginning in the state approximately equivalent to the application state of the first device.

10. The method of claim 1 wherein in response to a termination of an application session on the second device, the second application is removed from the second device, wherein the application session corresponds to the executing of the second application on the second device beginning in the state approximately equivalent to the application state of the first device.

11. The method of claim 1 further comprising:
determining whether the request for the application state is an authentic request,
wherein the transmitting of the second application includes transmitting the second application in response to a determination that the request is authentic, and
wherein the transmitting of the application state includes transmitting the application state in response to a determination that the request is authentic.

12. The method of claim 11 wherein the request from the second device is initiated by a user of the second device and wherein the determining whether the request is authentic includes determining whether the second application has been purchased or licensed by the user.

13. The method of claim 11, wherein at least a portion of the first and second applications are owned or licensed by a content owner and wherein the determining whether the request is authentic includes determining whether the second device has been registered with the content owner.

14. The method of claim 1 wherein the application state includes a state attribute comprising usage accounting data.

15. The method of claim 14 wherein the usage accounting data corresponds to one of usage minutes for an amount of time the first application is executing, a number of pages printed by the first application, a number of photos printed by the first application, and a number of words translated by the first application.

16. The method of claim 1 wherein the second device has a user account associated with the second device, the method further comprising:
determining whether the first application on the first device has been purchased or licensed;
receiving from the second device an amount of time that the second application executes; and
charging the user account a monetary amount that corresponds to the amount of time that the second application executes after determining that the first application has been purchased or licensed.

17. A machine implemented method comprising:
storing on a first device an application state of a first application executing on the first device;
receiving by the first device a request from a second device for the application state;
in response to the request from the second device, transmitting by the first device a second application to the second device; and
in response to the request from the second device, transmitting by the first device the application state of the first application to the second device,
wherein the second application is configured to execute on the second device so that the second application begins in a state approximately equivalent to the application state of the first device.

18. A machine for use with a first device having a first application and for use with a second device, the machine comprising:
a memory;
a processor coupled to the memory; and
a primary application stored in the memory and operable with the processor to perform steps comprising:
receiving by the processor of an application state of the first application executing on the first device;
receiving by the processor of a request from the second device for the application state;
in response to the request from the second device, transmitting by the processor a second application to the second device; and
in response to the request from the second device, transmitting by the processor the application state of the first application to the second device,
wherein the second application is configured to execute on the second device so that the second application begins in a state approximately equivalent to the application state of the first device.

19. A non-transitory, computer-readable storage medium containing instructions that, when executed by a processor, cause the processor to perform a method comprising:
receiving by the processor of an application state of a first application executing on a first device;
receiving by the processor of a request from a second device for the application state;
in response to the request from the second device, transmitting by the processor of a second application to the second device; and
in response to the request from the second device, transmitting by the processor the application state of the first application to the second device,
wherein the second application is configured to execute on the second device so that the second application begins in a state approximately equivalent to the application state of the first device.

20. A machine implemented method comprising:
identifying a first application session of a first user, wherein the first application session comprises an application server and a first device;
storing first device-side session information and server-side session information;
establishing a communication connection between a second device and the application server;
establishing a communication connection between a third device and the application server;
conveying the first device-side session information to the second device;
conveying the first device-side session information to the third device;
conducting a second application session of a second user, wherein the second application session comprises the second device and the application server, and begins in a state approximately equivalent to a state in which the first application session had been saved; and
conducting a third application session of a third user, wherein the third application session comprises the third device and the application server, and begins in a state approximately equivalent to a state in which the first application session had been saved,
wherein the first user, the second user and the third user are different individuals.

21. The method of claim 20 wherein the conducting of the second application session occurs during a first time period, and the conducting of the third application session occurs during a second time period, and wherein at least a portion of each of the first and second time periods overlap with one another.

22. The method of claim 20 further comprising:
determining whether the second user is authorized for use of the second application session; and
determining whether the third user is authorized for use of the third application session,
wherein the conducting of the second application session includes conducting the second application session in response to a determination that the second user is authorized for use of the second application session, and
wherein the conducting of the third application session includes conducting the third application session in response to a determination that the third user is authorized for use of the third application session.

23. The method of claim 22 wherein the determining of whether the second user is authorized for use of the second application session includes determining whether the second user has a license for use of the second application session, and wherein the determining of whether the third user is authorized for use of the third application session includes determining of whether the third user has a license for use of the third application session.

24. The method of claim 20 wherein at least a portion of the first, second and third application sessions are generated by at least one application that is owned or licensed by a content owner, the method further comprising:
determining whether the second device has been registered with the content owner; and
determining whether the third device has been registered with the content owner,
wherein the conducting of the second application session includes conducting the second application session in response to a determination that the second device has been registered with the content owner, and
wherein the conducting of the third application session includes conducting the third application session in response to a determination that the third device has been registered with the content owner.

25. A machine implemented method comprising:
identifying an application first session, an application second session and an application third session, each of which comprises an application server and a first device, and each of which is based upon executing a primary application by the application server;
storing first device-side first session information and server-side first session information corresponding to the application first session;
storing first device-side second session information and server-side second session information corresponding to the application second session;
storing first device-side third session information and server-side third session information corresponding to the application third session;
receiving from a second device a request for a state at which one of the application first session, the application second session, and the application third session had been saved, wherein the second device is configured to provide an option for selecting any of the states at which the application first session, the application second session, and the application third session had been saved;
conveying to the second device the state requested by the second device; and
conducting an application fourth session comprising the second device and the application server wherein the application fourth session begins in a state approximately equivalent to the requested state, and wherein the application fourth session is based upon executing the primary application by the application server.

26. The method of claim 25 wherein each of the application first session, the application second session and the application third session occurs respectively during a first time period, a second time period and a third time period, wherein the conducting of the application fourth session occurs during a fourth time period, and wherein the fourth time period does not overlap with any one of the first time period, the second time period and the third time period.

27. The method of claim 25 wherein the application first session, the application second session and the application third session are conducted on the first device by a first user, wherein the application fourth session is conducted on the second device by a second user, and wherein the first and second users are different individuals.

28. The method of claim 27 further comprising:
determining whether the second user is authorized for use of the application fourth session,
wherein the conducting of the application fourth session includes conducting the application fourth session in response to a determination that the second user is authorized for use of the application fourth session.

29. The method of claim 28 wherein the determination of whether the second user is authorized for use of the application fourth session includes a determination of whether the second user has a license for use of the application fourth session.

30. The method of claim 25 wherein at least a portion of the primary application is owned or licensed by a content owner, the method further comprising:
determining whether the second device has been registered with the content owner,
wherein the conducting of the application fourth session includes conducting the application fourth session in response to a determination that the second device has been registered with the content owner.

31. A machine for use with a first device, a second device and a third device, the machine comprising:
a memory;
a processor coupled to the memory; and
an application stored in the memory and operable with the processor to perform steps comprising:
identifying a first application session of a first user, wherein the first application session comprises the processor and the first device;
storing first device-side session information and processor-side session information;
establishing a communication connection between the second device and the processor;
establishing a communication connection between the third device and the processor;
conveying the first device-side session information to the second device;
conveying the first device-side session information to the third device;
conducting a second application session of a second user, wherein the second application session comprises the second device and the processor, and begins in a state approximately equivalent to a state in which the first application session had been saved; and
conducting a third application session of a third user, wherein the third application session comprises the third device and the processor, and begins in a state approximately equivalent to a state in which the first application session had been saved,
wherein the first user, the second user and the third user are different individuals.

32. A machine for use with a first device and a second device, the machine comprising:
a memory;
a processor coupled to the memory; and
an application stored in the memory and operable with the processor to perform steps comprising:
identifying an application first session, an application second session and an application third session, each of which comprises the processor and the first device, and each of which is based upon executing a primary application by the processor;
storing first device-side first session information and processor-side first session information corresponding to the application first session;
storing first device-side second session information and processor-side second session information corresponding to the application second session;
storing first device-side third session information and processor-side third session information corresponding to the application third session;
receiving from the second device a request for a state at which one of the application first session, the application second session, and the application third session had been saved, wherein the second device is configured to provide an option for selecting any of the states at which the application first session, the application second session, and the application third session had been saved;
conveying to the second device the state requested by the second device; and
conducting an application fourth session comprising the second device and the processor, wherein the application fourth session begins in a state approximately equivalent to the requested state, and wherein the application fourth session is based upon executing the primary application by the processor.

33. A non-transitory, computer-readable storage medium containing instructions that, when executed by a processor, cause the processor to perform a method comprising:
identifying a first application session of a first user, wherein the first application session comprises the processor and a first device;
storing first device-side session information and processor-side session information;
establishing a communication connection between a second device and the processor;
establishing a communication connection between a third device and the processor;
conveying the first device-side session information to the second device;
conveying the first device-side session information to the third device;
conducting a second application session of a second user, wherein the second application session comprises the second device and the processor, and begins in a state approximately equivalent to a state in which the first application session had been saved; and
conducting a third application session of a third user, wherein the third application session comprises the third device and the processor, and begins in a state approximately equivalent to a state in which the first application session had been saved,
wherein the first user, the second user and the third user are different individuals.

34. A non-transitory, computer-readable storage medium containing instructions that, when executed by a processor, cause the processor to perform a method comprising:
identifying an application first session, an application second session and an application third session, each of which comprises the processor and the first device, and each of which is based upon executing a primary application by the processor;
storing first device-side first session information and processor-side first session information corresponding to the application first session;
storing first device-side second session information and processor-side second session information corresponding to the application second session;
storing first device-side third session information and processor-side third session information corresponding to the application third session;
receiving from a second device a request for a state at which one of the application first session, the application second session, and the application third session had been saved, wherein the second device is configured to provide an option for selecting any of the states at which the application first session, the application second session, and the application third session had been saved;
conveying to the second device the state requested by the second device; and
conducting an application fourth session comprising the second device and the processor wherein the application fourth session begins in a state approximately equivalent to the requested state, and wherein the application fourth session is based upon executing the primary application by the processor.
